(19) United States
(12) Patent Application Publication
(10) Pub. No.: US 2024/0072232 A1
(43) Pub. Date: Feb. 29, 2024

(54) LOW-TORTUOSITY ELECTRODES FOR SOLID-STATE LITHIUM-ION BATTERIES AND FABRICATION METHODS

(71) Applicant: FORD GLOBAL TECHNOLOGIES, LLC, Dearborn, MI (US)

(72) Inventors: Zijie Lu, Novi, MI (US); Xiaojiang Wang, Saline, MI (US); Andrew Robert Drews, Ann Arbor, MI (US); Brian Joseph Robert, St Clair Shores, MI (US); Lingyun Liu, Northville, MI (US)

(21) Appl. No.: 17/897,856

(22) Filed: Aug. 29, 2022

(51) Int. Cl. H01M 4/04; H01M 4/38; H01M 4/505; H01M 4/525; H01M 4/58; H01M 4/583; H01M 10/0525; H01M 10/0565

(52) U.S. Cl. CPC H01M 4/0416; H01M 4/386; H01M 4/505; H01M 4/525; H01M 4/5825; H01M 4/583; H01M 10/0525; H01M 10/0565; H01M 2004/027

(57) ABSTRACT

Various methods of making low-tortuosity electrodes are disclosed. In some embodiments, the low-tortuosity electrodes have a tortuosity of less than 2.0 or 1.4 and include battery-active material and solid electrolyte with the solid electrolyte having channels therein that are vertically aligned. A solid-state lithium-ion battery electrode is also disclosed.

### TECHNICAL FIELD

The present disclosure relates to electrodes. The electrodes can be used, for example, in solid-state batteries (“SSBs”) and lithium-ion (“Li-ion”) batteries (“LIBs”).

### BACKGROUND

Widespread adoption of electric vehicles (“EVs”) and renewable energy technology may require lithium-ion batteries of higher energy-density and lower expense. The fundamental approach to achieving this target is to find new electrode materials or new battery chemistries that promise to offer high energy-density. However, this approach may take a long time for the new materials-based technologies to mature. Thus, it may be helpful to develop other engineering-based solutions.

### SUMMARY

A simple and straightforward approach to increasing energy density and reducing expense is to adopt thicker and/or denser electrodes. However, a thicker electrode could create issues like transport (species and charges) limitations as well as manufacturing challenges. Li-ion transport limitation within the electrode is a factor when considering the utilization of active-material and the high-rate operation of batteries.

The performance limitation of thick electrodes is related to the tortuous conduction pathways for Li-ions within the electrode. See, for example, FIG. 1. This can be explained with the relationship of effective Li⁺ diffusivity (D_{eff}) and the tortuosity (τ):

$${D}_{eff} = {D}_{0} \frac{ε}{τ} ,$$

where D₀ is the intrinsic Li⁺ diffusivity and ε is the volume fraction of the electrolyte.

Conventional electrodes, that are used in lithium-ion batteries and consist of isotropic particles, typically contain 30-40% porosity and have a tortuosity of 3 to 5. Thus, significantly lower Li⁺ conductivity is seen in the battery electrodes.

Li-ion transport limitation inside the electrodes of solid-state batteries SSB can be more stringent due to the point-point contact nature of the solid particles. Much higher resistance for ion transport in the composite electrodes can be obtained than in bulk electrolytes. Therefore, to achieve a comparable electrode ionic conduction to similar LIB electrodes (ε˜0.4, τ˜3.0), the conductivity of solid electrolytes (“SE”) should be >5-10 mS/cm. Only a few sulfide-based solid electrolytes possess this high Li⁺ conductivity. However, almost all these superconductive sulfides are not compatible with most of battery active materials, restricting their applications in SSB. Thus, less conductive but more stable electrolytes need to be used. Consequently, higher volume fraction (for example, >50%) of SE may be required, which reduces cell energy density.

Another area in which the Li-ion transport plays a role is in fast-charging. Growing demand for battery fast charging highlights the need for negative electrodes that can accept high rate charging without metal deposition. At high charging rates, overpotentials exist in every part of the battery cell, including diffusion of lithium ions inside active materials, charge transfer across phase boundaries, and transport of Li⁺ through electrolyte inside electrodes. These polarization effects lead to Li metal plating, reduced utilization of active materials, and temperature increases, thus limiting the fast-charging ability.

The transport of lithium ions inside the battery electrodes is one of the rate-limiting steps for enabling thick electrodes, high-rate operation, and fast-charging. The highly tortuous Li⁺ conduction pathways in current LIB electrodes is the fundamental cause of these issues.

Low tortuosity electrodes would increase the Li⁺ transport in electrodes, thus offering potential solutions to these issues without increasing the volume fraction of the electrolyte inside electrodes. The ideal conduction pathway for Li-ions in the electrodes is a straight channel, for which tortuosity τ=1 and the transport resistance for Li⁺ within electrode is minimized. There remains a need in the industry to lower the tortuosity of electrodes.

A method includes exposing a slurry comprising battery active material, solid electrolyte, polymer-encapsulated magnetic pore-formers, a binder, and a carbon additive to a magnetic field such that the magnetic field causes at least a portion of the encapsulated magnetic pore-formers to vertically align and form vertically aligned channels in the slurry, wherein the channels have a tortuosity of less than 2.0; and drying the slurry.

A solid-state lithium-ion battery electrode includes a slurry coating including battery active material, solid electrolyte, a binder, a carbon additive, and polymer-encapsulated magnetic pore-formers forming vertically aligned channels in the slurry coating. The channels have a tortuosity of less than 2.0.

A solid-state lithium-ion battery electrode includes a slurry coating including battery active material, solid electrolyte, a binder, and a carbon additive. The slurry coating comprises vertically aligned channels having a tortuosity of less than 2.0, and the channels contain a solid electrolyte comprising one or more of an inorganic sulfide, an inorganic oxide, and a solid polymer.

### BRIEF DESCRIPTION OF THE DRAWINGS

FIG. 1 discloses an example of a tortuous conduction pathway for Li-ions in a conventional electrode.

FIG. 2 discloses an example embodiment of a process for making low tortuosity electrodes.

FIG. 3 discloses an example embodiment of an electrode.

FIG. 4 discloses an example embodiment of an electrode.

FIG. 5 discloses an example embodiment of an electrode.

FIG. 6 discloses an example embodiment of an electrode.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

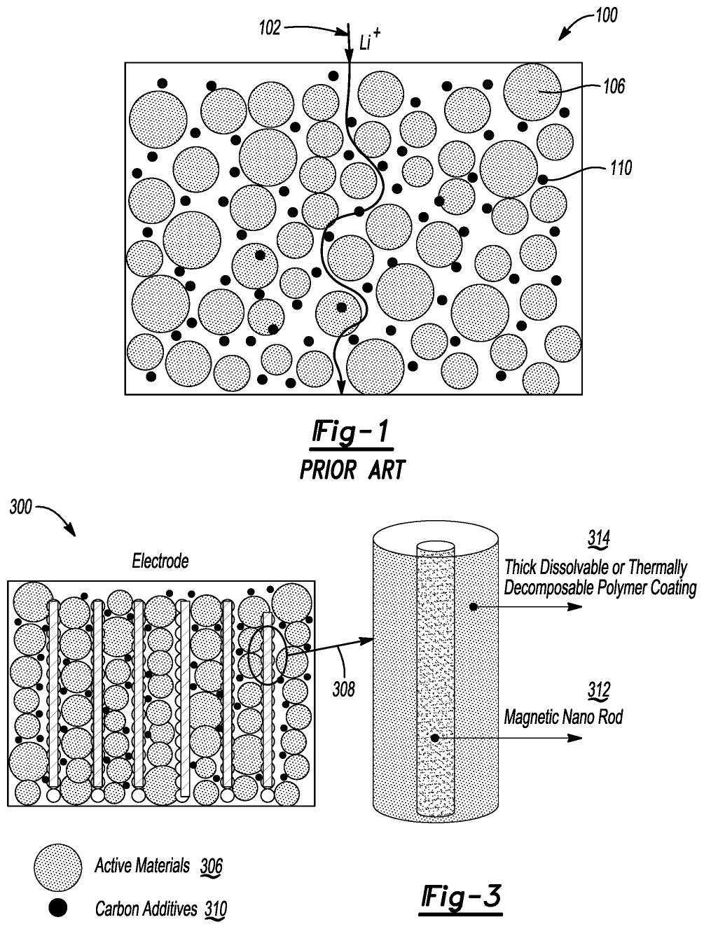

An example of Li-ion path 102 in a prior art electrode 100 is shown in FIG. 1. The electrode 100 includes battery active material 106 and carbon additive 110. As indicated in FIG. 1, the Li-ion path 102 is highly tortuous, which typically limits the Li-ion transport within the electrode 100. This Li-ion transport limitation within the electrode is a factor when considering the utilization of active-material and the high-rate operation of batteries.

The present disclosure presents a novel method for producing vertically aligned straight channels, with low tortuosity (i.e., close to 1), in the composite electrodes for SSBs, without increasing volume fraction of solid electrolytes. By vertically aligned it is meant herein that the channels are substantially parallel to the intended Li-ion path and substantially parallel to each other. A novel type of micron-sized, rodlike pore-formers, which are ferrimagnetic and encapsulated in inert polymers, is created to facilitate the formation of the parallel straight (i.e., low-tortuosity) channels in electrodes of SSBs.

The tortuosity in example embodiments were measured in accordance with the teachings of Bae et al.; Design of Battery Electrodes with Dual-Scale Porosity to Minimize Tortuosity and Maximize Performance; Advance Materials, Vol. 25, Issue 9; 2013; pp. 1254-1258. In some embodiments, the channels have a tortuosity of less than 2.0. In some preferred embodiments, the channels have a tortuosity of less than 1.4.

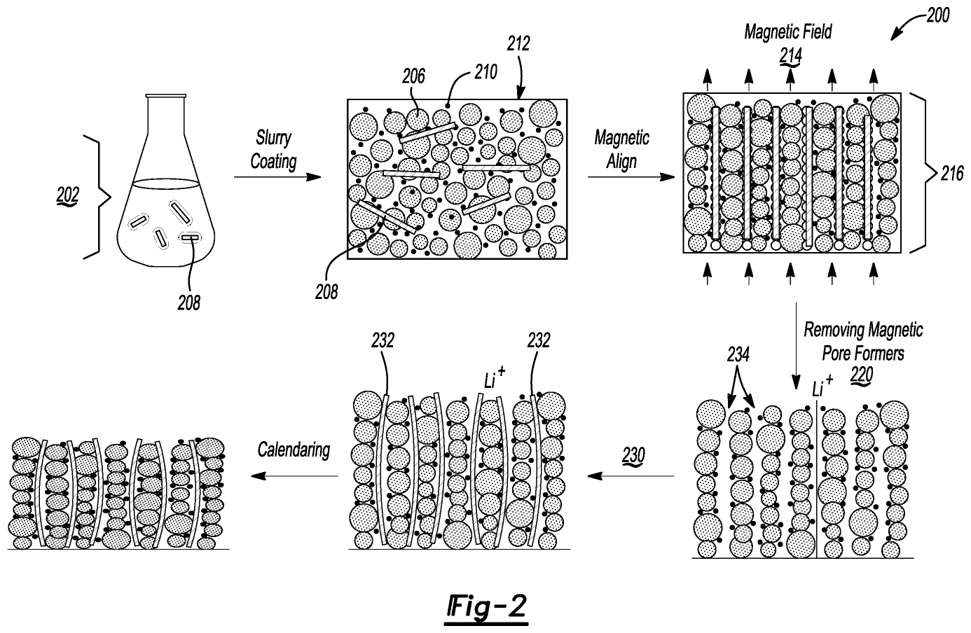

Referring to FIG. 2, an example embodiment of a process 200 for making low tortuosity electrodes is disclosed. FIG. 2 discloses a slurry 202 that is used in a slurry coating step 204. In some embodiments, the slurry 202 comprises battery-active material 206, solid electrolyte (not shown), polymer-encapsulated magnetic pore-formers 208, a binder (not shown), and a carbon additive 210.

The polymer-encapsulated magnetic pore-formers should have a width and length sufficient to create the channels for the desired Li-ion path. The carbon additive is added to enhance electric conductivity. In some embodiments, the slurry may include some amount of solid electrolyte (e.g., for better electrode/electrolyte contact). In other embodiments, the slurry will include no solid electrolyte. The fast ion conduction is achieved by incorporating vertically aligned channels in the slurry.

In some embodiments, the polymer-encapsulated magnetic pore-formers include magnetic particles that are encapsulated in a polymer. In some preferred embodiments, the magnetic particles are rod-shaped. In some preferred embodiments, the rod-shaped, magnetic particles have a width greater than 1 um and a length of about 12 um. Micron-sized rod-shaped magnetic pore-formers can be produced using methods such as those taught in Vereda, Langmuir, 23, 3581-3589 (2007) and Vereda, Colloids & Surfaces A, 319, 122-129 (2008). Magnetic materials useful for making the pore-formers include magnetite (Fe₃O₄), Ni ferrite, and Co ferrite.

The encapsulation of the magnetic particles can be produced by methods consistent with the teachings of Ferreira et al.; A review on fibre reinforced composite printing via FFF; Rapid Prototyping Journal (2019), Vol. 25, No. 6, pp. 972-988 and Nguyen et al.; Monodispersed polymer encapsulated superparamagnetic iron oxide nanoparticles for cell labeling, Polymer 106 (2016), pp. 238-248. In some embodiments, the polymer encapsulation comprises polyvinylidene difluoride (“PVDF”), poly (vinyl alcohol) (“PVA”), poly (acrylic acid) (“PAA”), polypropylene carbonate (“PPC”), polytetrafluoroethylene (“PTFE”), polyethylene (“PE”), polypropylene (“PP”), or polyether ether ketone (“PEEK”). In some preferred embodiments, the polymer encapsulation comprises a solid polymer electrolyte. Examples of some preferred solid polymer electrolytes comprise poly(ethylene oxide) (“PEO”)-based in-situ polymerized PEO-like electrolyte, or single-ion conduction polymer electrolyte.

Once the slurry is prepared it can be applied to an article in a slurry coating step 204. FIG. 2 discloses a slurry coating on an electrode 212. During or after the slurry coating step 204, the slurry is exposed to a magnetic field 214 to vertically align a portion of the polymer-encapsulated pore-formers 208. Preferably, most of the polymer-encapsulated pore-formers 208 become vertically aligned because of the exposure to the magnetic field 214. The magnetic field 214 may be applied using any suitable magnetic field source, such as a permanent magnet or an electromagnet. FIG. 2 discloses a slurry coating 216 comprising vertically aligned polymer-encapsulated magnetic pore-formers 208.

Depending on the intended application of the slurry coating, the magnetic particles may remain in the electrode coating even after complete drying of the electrode coating. In some embodiments, the magnetic particles (e.g., rod-shaped magnetic particles) are encapsulated by a polymer coating that is dissolvable in a solvent or decomposable at a low temperature (e.g., polypropylene carbonate). After forming an electrode with the polymer-encapsulated magnetic pore-formers being vertically aligned by a magnetic field and the slurry dried, the polymer encapsulations are then dissolved in the solvent or decomposed by heating to the decomposing temperature, leaving the magnetic particles behind in the electrode. The magnetic particles can be removed after calendaring the electrode. Preferably, the magnetic particles are chosen to be electrochemically inactive with respect to the electrode in which they are used. For example, Ni can be used instead of Fe for use in a cathode).

Referring to FIG. 3, an electrode 300 is disclosed. The electrode 300 comprises battery-active material 306, solid electrolyte (not shown), polymer-encapsulated magnetic pore-formers 308, a binder (not shown), and a carbon additive 310. The polymer-encapsulated magnetic pore-formers 308 are vertically aligned. The polymer-encapsulated magnetic pore-formers 308 comprise rod-shaped magnetic particles 312. The magnetic particles 312 are encapsulated with a thick polymer coating 314 that is dissolvable or thermally decomposable.

In some embodiments, the magnetic particles are embedded in an ionic conductive polymer coating (i.e., a solid polymer electrolyte). After forming the electrode with the polymer-encapsulated magnetic pore-formers being vertically aligned in a magnetic field and dried, the polymer-encapsulated magnetic pore-formers can be retained to function as the ionic conductive path. As an ionically conductive solid body, the polymer-encapsulated magnetic pore-formers may retain their structure during calendaring and eliminate the need for a subsequent washing or decomposition step to remove pore-former materials.

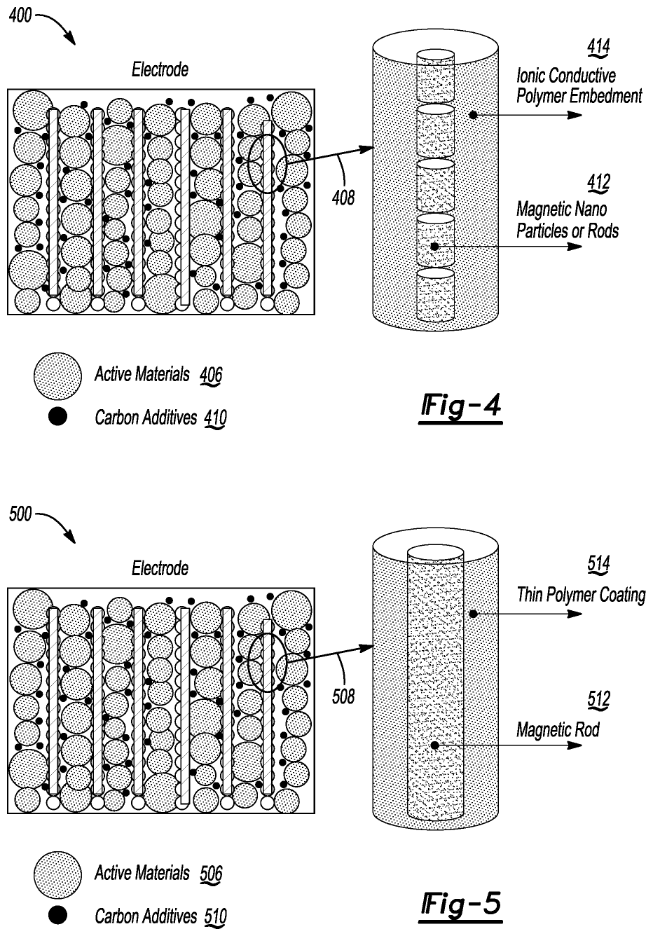

Referring to FIG. 4, an electrode 400 is disclosed. The electrode 400 comprises battery-active material 406, solid electrolyte (not shown), polymer-encapsulated magnetic pore-formers 408, a binder (not shown), and a carbon additive 410. The polymer-encapsulated magnetic pore-formers 408 are vertically aligned. The polymer-encapsulated magnetic pore-formers 408 comprise magnetic particles 412. In some embodiments, the magnetic particles 412 comprised rod-shaped magnetic particles. The magnetic particles 412 are embedded in an ionic conductive polymer embedment 414.

In some embodiments, the magnetic particles are encapsulated in a thin polymer coating. After forming the electrode with the polymer-encapsulated pore-formers being vertically aligned, the polymer coating of the pore-formers is dissolved in a selected solvent that is not a solvent for the electrode binder. The magnetic particles are mechanically removed by using magnetic force either while the polymer coating is removed with the solvent or, in other embodiments, the magnetic particles are removed separately from the polymer removing operation. The magnetic force that is used to remove the magnetic particles of the pore-formers will generally be different from that for vertically aligning the polymer-encapsulated pore-former during the electrode forming process. The magnetic field used to remove the pore former may include both a constant field, an alternating (AC) field or a pulsed field, while the aligning magnetic field is a steady (DC) field.

Referring to FIG. 5, an electrode 500 is disclosed. The electrode 500 comprises battery-active material 506, solid electrolyte (not shown), polymer-encapsulated magnetic pore-formers 508, a binder (not shown), and a carbon additive 510. The polymer-encapsulated magnetic pore-formers 508 are vertically aligned. The polymer-encapsulated magnetic pore-formers 508 comprise magnetic particles 512. In some embodiments, the magnetic particles 512 comprised rod-shaped magnetic particles. The magnetic particles 512 are embedded in an ionic conductive polymer embedment 514.

In some embodiments, the magnetic particles are embedded in a polymer coating. After forming the electrode with the pore formers being vertically aligned in a magnetic field and dried, the polymer coating of the pore forming body is subsequently dissolved in a selected solvent or decomposed by heating. The magnetic particles can be left behind or the magnetic particles can be removed by washing or by using magnetic force, for example, during the polymer removal operation.

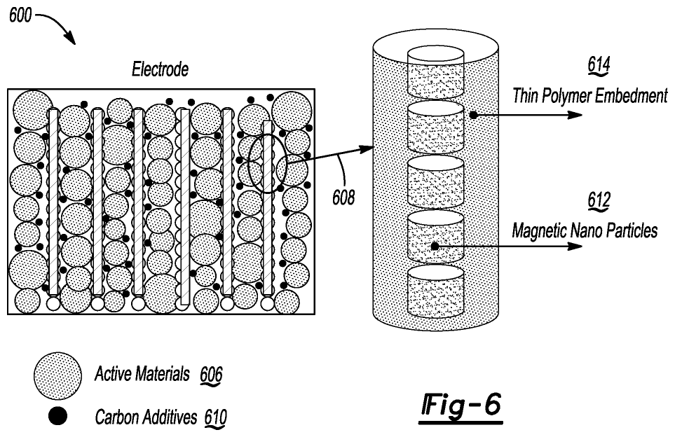

Referring to FIG. 6, an electrode 600 is disclosed. The electrode 600 comprises battery-active material 606, solid electrolyte (not shown), polymer-encapsulated magnetic pore-formers 608, a binder (not shown), and a carbon additive 610. The polymer-encapsulated magnetic pore-formers 608 are vertically aligned. The polymer-encapsulated magnetic pore-formers 608 comprise magnetic particles 612. The magnetic particles 612 are embedded in a polymer coating 614. The polymer coating 614 is dissolvable or thermally decomposable.

In some embodiments wherein the polymer-encapsulated magnetic pore-formers are removed from the slurry coating after the coating is dried, a solid electrolyte can be introduced into the channels. In some embodiments, the introducing of a solid electrolyte comprises solution infiltration. The electrode can then be subjected to a calendaring process.

Referring to FIG. 2, process 200 includes a step 220 that removes the polymer-encapsulated magnetic pore-formers 208 after the coating 216 is dried. In step 230, solid electrolyte 232 is introduced into the channels 234 of the dried coating.

The present disclosure can be used to achieve low-tortuosity ion conduction in electrodes of both SSBs and LIBs.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method comprising:
exposing a slurry comprising battery active material, solid electrolyte, polymer-encapsulated magnetic pore-formers, a binder, and a carbon additive to a magnetic field such that the magnetic field causes at least a portion of the encapsulated magnetic pore-formers to vertically align and form vertically aligned channels in the slurry, wherein the channels have a tortuosity of less than 2.0; and
drying the slurry.

2. The method of claim 1, wherein the channels have a tortuosity of less than 1.4.

3. The method of claim 1, wherein the polymer encapsulating the polymer-encapsulated magnetic pore-formers comprises a solid polymer electrolyte.

4. The method of claim 3, wherein the solid polymer electrolyte comprises poly(ethylene oxide) (“PEO”)-based in-situ polymerized PEO-like electrolyte, or single-ion conduction polymer electrolyte.

5. The method of claim 1, wherein the polymer-encapsulated magnetic pore-formers include magnetic particles that are rod-shaped.

6. The method of claim 5, wherein the rod-shaped magnetic particles have a width greater than 1 urn and a length of about 12 urn.

7. The method of claim 1, wherein the magnetic particles include particles comprising magnetite, nickel ferrite, or cobalt ferrite.

8. The method of claim 1, further comprising:
at least partially removing the polymer-encapsulated magnetic pore-formers; and
introducing solid electrolyte into the channels.

9. The method of claim 8, wherein introducing a solid electrolyte comprises solution infiltration.

10. The method of claim 8, wherein the solid electrolyte introduced into the channels comprises one or more of an inorganic sulfide, an inorganic oxide, and a solid polymer.

11. A solid-state lithium-ion battery electrode comprising:
a slurry coating including battery active material, solid electrolyte, a binder, a carbon additive, and polymer-encapsulated magnetic pore-formers forming vertically aligned channels in the slurry coating, wherein the channels have a tortuosity of less than 2.0.

12. The electrode of claim 11, wherein the channels have a tortuosity of less than 1.4.

13. The electrode of claim 11, wherein the polymer-encapsulated pore-formers include magnetic particles that are rod-shaped.

14. The electrode of claim 13, wherein the magnetic particles have a width greater than 1 urn and a length of about 12 um.

15. The electrode of claim 11, wherein the polymer encapsulating the polymer-encapsulated magnetic pore-formers comprises a solid polymer electrolyte.

16. The electrode of claim 15, wherein the solid polymer electrolyte comprises poly(ethylene oxide) (“PEO”)-based in-situ polymerized PEO-like electrolyte, or single-ion conduction polymer electrolyte.

17. A solid-state lithium-ion battery electrode comprising:
a slurry coating including battery active material, solid electrolyte, a binder, and a carbon additive, wherein the slurry coating comprises vertically aligned channels having a tortuosity of less than 2.0, and the channels contain a solid electrolyte comprising one or more of an inorganic sulfide, an inorganic oxide, and a solid polymer.

18. The electrode of claim 17, wherein the channels have a tortuosity of less than 1.4.

19. The electrode of claim 17, wherein the electrode is an anode, and the active material comprises silicon metal, silicon oxide (SiOₓ, 0<x<2), silicon-carbon composite, or graphite.

20. The electrode of claim 17, wherein the electrode is a cathode, and the active material comprises lithium cobalt oxide (LCO), lithium nickel cobalt manganese oxide (NCM), lithium nickel cobalt aluminum oxide (NCA), lithium iron phosphate (LFP), or a conversion material (such as S, FeS₂, etc.) for positive (cathode) electrode.
